(19) United States
(12) Patent Application Publication
(10) Pub. No.: US 2019/0287473 A1
(43) Pub. Date: Sep. 19, 2019

(54) LIQUID CRYSTAL DISPLAY DEVICE AND DRIVE METHOD FOR SAME

(71) Applicant: SHARP KABUSHIKI KAISHA, Sakai City, Osaka (JP)

(72) Inventor: MASAKATSU TOMINAGA, Sakai City (JP)

(73) Assignee: SHARP KABUSHIKI KAISHA, Sakai City, Osaka (JP)

(21) Appl. No.: 16/334,930

(22) PCT Filed: Dec. 27, 2017
(86) PCT No.: PCT/JP2017/046888

§ 371 Date: Mar. 20, 2019

(30) Foreign Application Priority Data
Jan. 5, 2017 (JP) 2017-000468

(51) Int. Cl. G09G 3/36; G02F 1/1362; G02F 1/133

(52) U.S. Cl. CPC G09G 3/3648; G02F 1/13306; G02F 1/136286

(57) ABSTRACT

In a liquid crystal display device, pixel circuits are alternately connected to both sides of a data line in units of n (n is an integer not smaller than one), and a data line drive circuit applies voltages of different polarities to adjacent data lines. The pixel circuits are arranged so that a row in which the pixel circuits of three primary colors are aligned in an order of red, green, and blue, a row in which the pixel circuits of the three primary colors are aligned in an order of blue, red, and green, and a row in which the pixel circuits of the three primary colors are aligned in an order of green, blue, and red are aligned in units of n in a column direction. When displaying a greenish pattern, display colors of pixels in 3n rows are averaged and a color of a display screen is prevented from becoming greenish gray. With this, a liquid crystal display device which performs a Z-inversion drive and can prevent a color shift when displaying a specific pattern is provided.

### TECHNICAL FIELD

The present invention relates to an active matrix type liquid crystal display device and a drive method for same.

### BACKGROUND ART

A liquid crystal display device is widely used as a thin, light-weight, low power consumption display device. The liquid crystal display device has a structure in which a TFT (Thin Film Transistor) substrate having TFTs formed thereon and a color filter substrate provided with a color filter are bonded to each other and liquid crystal is sealed between the two substrates. If a voltage of a same polarity is applied to the liquid crystal continuously, the liquid crystal display device deteriorates quickly. Therefore, the liquid crystal display device performs an AC drive in which a polarity of a voltage written to a pixel circuit corresponding to a sub pixel (or pixel) is inverted at a predetermined cycle.

There are some kinds of the AC drive, such as a frame inversion drive, a line inversion drive, column inversion drive, and a dot inversion drive. Among them, the column inversion drive is a drive method in which the polarity of the voltage written to the pixel circuit is inverted every column of the pixel circuits. In a liquid crystal display device performing the column inversion drive, a stripe pattern extending in a same direction as data lines may occur in a display screen. Thus, a 1H-Z inversion drive is known as a drive method for suppressing the stripe pattern. Furthermore, a 2H-Z inversion drive is known as a drive method which can reduce power consumption when displaying a red, green, or blue image while preventing the stripe pattern.

FIG. 19 is a diagram showing the polarities of the voltages written to the pixel circuits when performing the AC drive. In the column inversion drive (FIG. 19(a)), the pixel circuits in each column are connected to a same side of the data line, and voltages of different polarities are applied to adjacent data lines. Thus, the polarity of the voltage written to the pixel circuit is inverted every column of the pixel circuits. In the 1H-Z inversion drive (FIG. 19(b)), the pixel circuits are alternately connected to both sides of the data dine in units of one, and the voltages of different polarities are applied to the adjacent data lines. Thus, the polarity of the voltage written to the pixel circuit is inverted every row and every column of the pixel circuits. In the 1H-Z inversion drive, although the polarities of the voltages applied to the data line are same as those in the column inversion drive, the polarities of the voltages written to the pixel circuits (polarity pattern) are same as those in the dot inversion drive. In the 2H-Z inversion drive (FIG. 19(c)), the pixel circuits are alternately connected to both sides of the data line in units of two, and the voltages of different polarities are applied to the adjacent data lines. Thus, the polarity of the voltage written to the pixel circuit is inverted every two rows and every column of the pixel circuits. Note that in any drive method, the polarity of the voltage written to the pixel circuit is inverted in a next frame.

Related to the invention of the application, Patent Document 1 discloses a matrix type color display device in which a row in which pixel circuits of three primary colors are arranged in an order or red, green, and blue and a row in which the pixel circuits of the three primary colors are arranged in an order of blue, green, and red are alternately arranged in a column direction. Patent Documents 2 and 3 disclose a liquid crystal display device performing the 2H-Z inversion drive.

### PRIOR ART DOCUMENTS

### Patent Documents

[Patent Document 1] Japanese Laid-Open Patent Publication No. 2001-343636

[Patent Document 2] International Publication No. 2014/185122

[Patent Document 3] Japanese Laid-Open Patent Publication No. 2003-233362

### SUMMARY OF THE INVENTION

### Problems to Be Solved by the Invention

In recent years, a number of liquid crystal display devices performing the 2H-Z inversion drive is increasing. However, in the liquid crystal display device performing the 2H-Z inversion drive, when displaying a specific pattern, there occurs a phenomenon that the color of the display screen looks a color slightly mixed with another color rather than a correct color (expected color) (this phenomenon is hereinafter referred to as a color shift). For example, when white and black are displayed in a checkerboard pattern in units of pixels in two rows and one column as shown in FIG. 7 described later, the color of the display screen looks greenish gray rather than gray.

Therefore, providing a liquid crystal display device which performs a Z inversion drive and can prevent a color shift when displaying a specific pattern is taken as a problem.

### Means for Solving the Problems

The above-described problem can be solved for example, by a following liquid crystal display device. The liquid crystal display device is an active matrix type liquid crystal display device including: scanning lines extending in a row direction; data lines extending in a column direction; pixel circuits, each arranged corresponding to an intersection of the scanning line and the data line and connected to one corresponding data line; a scanning line drive circuit configured to select the scanning lines sequentially; and a data line drive circuit configured to drive the data lines, wherein the data line drive circuit applies voltages of different polarities to adjacent data lines, the pixel circuits are alternately connected to both sides of the data line in units of a predetermined number, the number being not smaller than one, and the pixel circuits are arranged so that a row in which the pixel circuits of three primary colors are aligned in an order of red, green, and blue, a row in which the pixel circuits of the three primary colors are aligned in an order of blue, red, and green, and a row in which the pixel circuits of the three primary colors are aligned in an order of green, blue, and red are aligned in units of the number in the column direction.

The above-described problem can also be solved for example, by a following drive method for a liquid crystal display device. The drive method for the liquid crystal display is a drive method for an active matrix type liquid crystal display device having scanning lines extending in a row direction, data lines extending in a column direction, and pixel circuits, each arranged corresponding to an intersection of the scanning line and the data line and connected to one corresponding data line, the method comprising steps of: selecting the scanning lines sequentially; and driving the data lines, wherein in driving the data lines, voltages of different polarities are applied to adjacent data lines, the pixel circuits are alternately connected to both sides of the data line in units of a predetermined number, the number being not smaller than one, and the pixel circuits are arranged so that a row in which the pixel circuits of three primary colors are aligned in an order of red, green, and blue, a row in which the pixel circuits of the three primary colors are aligned in an order of blue, red, and green, and a row in which the pixel circuits of the three primary colors are aligned in an order of green, blue, and red are aligned in units of the number in the column direction.

### Effects of the Invention

According to such a liquid crystal display device and such a drive method for the liquid crystal display device, by applying the voltages of different polarities to the adjacent data lines under circumstances where the pixel circuits are alternately arranged on both sides of the data line in units of n (n is an integer not smaller than one), an nH-Z inversion drive can be performed. With this, as a value of n is larger, power consumption when displaying a red, green, or blue image can be reduced. Furthermore, since the pixel circuits of the three primary colors are arranged in units of n row(s) in three types of orders, even when displaying a specific pattern which causes a color shift, display colors of pixels in 3n rows are averaged and the color shift can be prevented.

### BRIEF DESCRIPTION OF THE DRAWINGS

FIG. 1 is a block diagram showing a configuration of a liquid crystal display device according to a first embodiment.

FIG. 2 is a circuit diagram of a display area shown in FIG. 1.

FIG. 3 is a layout diagram of the display area shown in FIG. 1.

FIG. 4 is an enlarged view of a portion X in FIG. 3.

FIG. 5 is a cross-sectional view taken along a line A-A′ in FIG. 4.

FIG. 6 is a cross-sectional view taken along a line B-B′ in FIG. 4.

FIG. 7 is a diagram showing status when a conventional liquid crystal display device displays a greenish pattern.

FIG. 8 is a diagram showing directions in which polarities of voltages applied to data lines are made to change in a case shown in FIG. 7.

FIG. 9 is a diagram showing an arrangement of pixel circuits in the liquid crystal display device shown in FIG. 1.

FIG. 10 is a diagram showing status when the liquid crystal display device shown in FIG. 1 displays the greenish pattern.

FIG. 11 is a diagram showing directions in which polarities of voltages applied to data lines are made to change in a case shown in FIG. 10.

FIG. 12 is a diagram showing status when the liquid crystal display device shown in FIG. 1 displays another pattern.

FIG. 13 is a diagram showing an arrangement of pixel circuits in a liquid crystal display device according to a modification of the first embodiment.

FIG. 14 is a layout diagram of a display area of a liquid crystal display device according to a second embodiment.

FIG. 15 is a circuit diagram of a display area of a liquid crystal display device according to a third embodiment.

FIG. 16 is a diagram showing an arrangement of pixel circuits in the liquid crystal display device according to the third embodiment.

FIG. 17 is a diagram showing status when the liquid crystal display device according to the third embodiment displays a greenish pattern.

FIG. 18 is a diagram showing directions in which polarities of voltages applied to data lines are made to change in a case shown in FIG. 17.

FIG. 19 is a diagram showing polarities of voltages written to pixel circuits when performing an AC drive.

### MODES FOR CARRYING OUT THE INVENTION

### First Embodiment

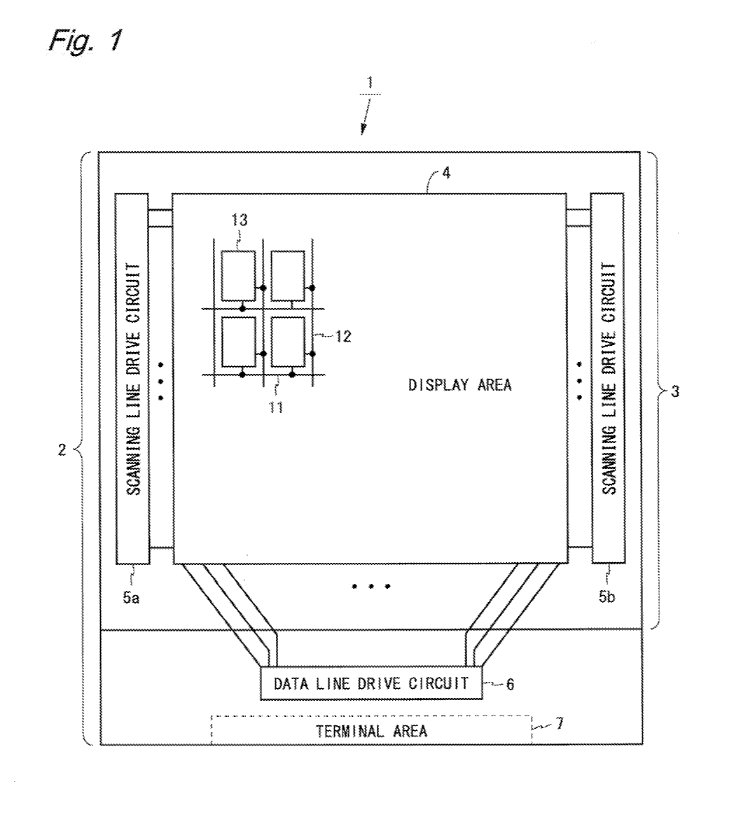

FIG. 1 is a block diagram showing a configuration of a liquid crystal display device according to a first embodiment. A liquid crystal device 1 shown in FIG. 1 is an active display matrix type display device having a structure in which a TFT substrate 2 and a color filter substrate 3 are bonded to each other and liquid crystal is sealed between the two substrates. The liquid crystal display device 1 displays a color image lasing pixel circuits of three primary colors. The liquid crystal display device 1 includes a backlight not shown in the drawings. Hereinafter, a horizontal direction of the drawings is referred. to as a row direction, a vertical direction of the drawings is referred to as a column direction, a pixel circuit for displaying red is referred to as an a pixel circuit, a pixel for displaying green is referred to as a G pixel circuit, and a pixel circuit for displaying blue is referred to as a B pixel circuit. Furthermore, subpixels corresponding to the pixel circuits of the three primary colors are referred to as an R subpixel, a G subpixel, and a B subpixel.

The TFT substrate 2 is provided with a display area 4. Scanning lines 11, data lines 12, and pixel circuits 13 are formed in the display area 4. The scanning lines 11 extend in the row direction and are arranged in parallel to each other. The data lines 12 extend in the column direction and are arranged in parallel to each other so as to intersect with the scanning lines 11 perpendicularly. The pixel circuit 13 is arranged. corresponding to an intersection of the scanning line 11 and the data line 12. The pixel circuit 13 is connected to one corresponding scanning line 11 and one corresponding data line 12. The pixel circuit 13 functions as one of the R pixel circuit, the G pixel circuit, and the B pixel circuit. Note that the scanning line 11 may be called a gate line and the data line 12 may be called a source line.

Scanning line drive circuits 5a, 5b are formed outside the display area 4. The scanning line drive circuits 5a, 5b are monolithically formed on the TFT substrate 2 together with the pixel circuits 13 and the like. In FIG. 1, the scanning line drive circuit 5a is arranged on the left side of the display area 4, and the scanning line drive circuit 5b is arranged on the right side of the display area 4. One end of the scanning line 11 is connected to the scanning line drive circuit 5a, and the other end of the scanning line 11 is connected to the scanning line drive circuit 5b. The scanning line 11 is driven from both ends by the scanning: line drive circuits 5a, 5b. Note that one scanning line drive circuit may drive odd-numbered scanning lines 11 and the other scanning line drive circuit may drive even-numbered scanning lines 11. Alternatively, the scanning line drive circuit may be arranged only on one side of the display area 4. In a portion where the TFT substrate 2 and the color filter substrate 3 do not overlap, an IC chip including a data line drive circuit 6 is mounted and a terminal area 7 for arranging external connection terminals (not shown) is provided.

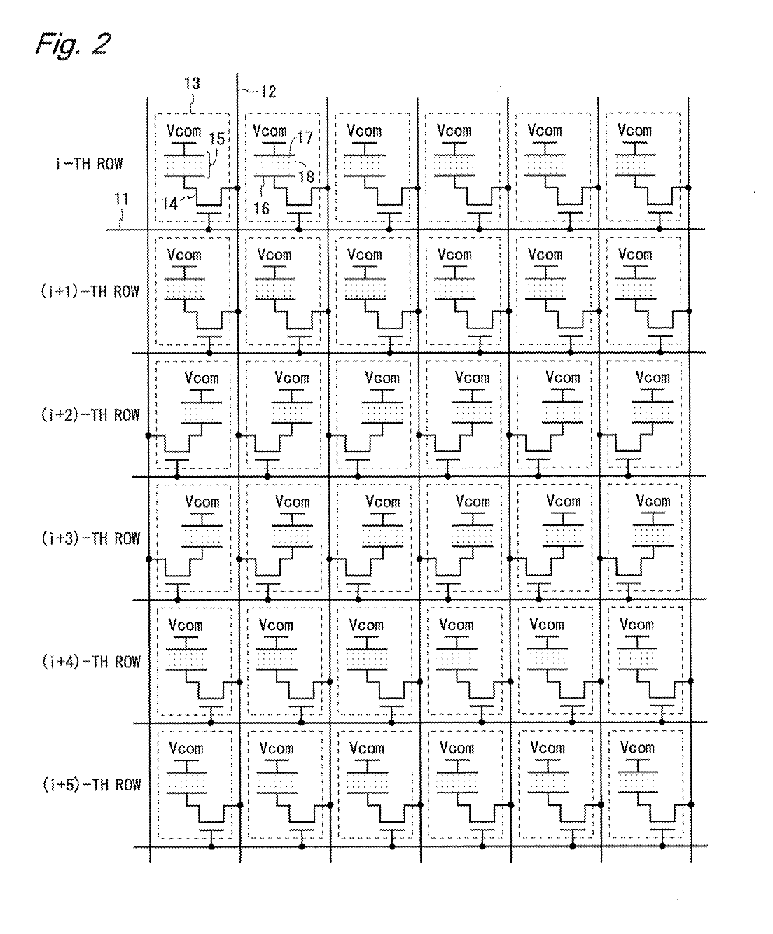

FIG. 2 is a circuit diagram of the display area 4. As shown in FIG. 2, the pixel circuit 13 includes a TFT 14 and a pixel capacitance 15. The pixel capacitance 15 has a structure in which liquid crystal 18 is sandwiched between a pixel electrode 16 and a common electrode 17. A gate electrode of the TFT 14 is connected to the corresponding scanning line 11, a source electrode of the TFT 14 is connected to the corresponding data line 12, and a drain electrode of the TFT 14 is connected to a corresponding pixel electrode 16. The common electrode 17 is formed using a transparent metal material such as ITO (Indium in Oxide) or the like. A common electrode voltage Vcom common to all the pixel circuits 13 is applied to the common electrode 17. The common electrode voltage Vcom is applied from the external connection terminal to the common electrode 17 by using a wiring not shown in the drawings (wiring in a same wiring layer as the scanning line 11 or the data line 12).

The scanning line drive circuits 5a, 5b drive the scanning lines 11, and the data line drive circuit 6 drives the data lines 12. More specifically, the scanning line drive circuits 5a, 5b sequentially select one scanning line 11 from the scanning lines 11, and apply a gate-on voltage (voltage with which the TFT 14 turns on) to the selected scanning line 11. With this, the TFTs 14 included in the pixel circuits 13 in one row turn on. The data line drive circuit 6 respectively applies voltages depending on a video signal to the data lines 12. With this, the voltages depending on the video signal are respectively written to the pixel electrodes 16 included in the pixel circuits 13 in one row.

A difference voltage between the voltage of the pixel electrode 16 and the common electrode voltage Vcom is applied to the liquid crystal 18. Transmittance (and luminance) of a subpixel corresponding to the pixel circuit 13 (subpixel realized by the pixel circuit 13) is changed depending on the voltage applied to the liquid crystal 18 (that is determined in accordance with the voltage written to the pixel circuit 13). Therefore, a desired image can be displayed by writing the voltages depending on the video signal to all the pixel circuits 13 included in the display area 4 using the scanning line drive circuits 5a, 5b and the data line drive circuit 6.

The liquid crystal display device 1 is a normally black type liquid crystal display device. In the liquid crystal display device 1, an FFS (Fringe Field Switching) method for applying transverse electric field to the liquid crystal 18 is adopted as an orientation method. Therefore, slits are formed on the pixel electrode 16, and the common electrode 17 is formed in an upper layer of the pixel circuit 13 and the like in the TFT substrate 2. In this manner, the pixel circuit 13 includes the pixel electrode 16 and the common electrode 17 both corresponding to the FFS method.

Furthermore, the liquid crystal display device performs a 2H-Z inversion drive. Therefore, the pixel circuits 13 are alternately connected to both sides of the data line 12 in units of two. Specifically, as shown in FIG. 2, the pixel circuits 13 in an i-th row, an (i+1)-th row, and the like are connected to the left side of the data line 12, and the pixel circuits 13 in an (i+2)-th row, an (i+3)-th row, and the like are connected to the right side of the data line 12.

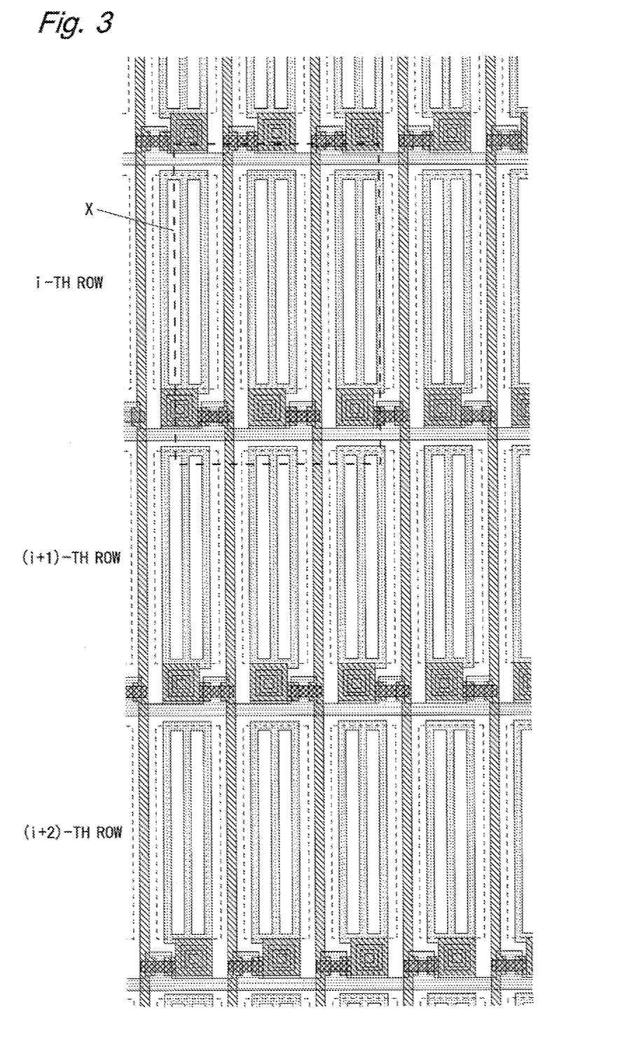

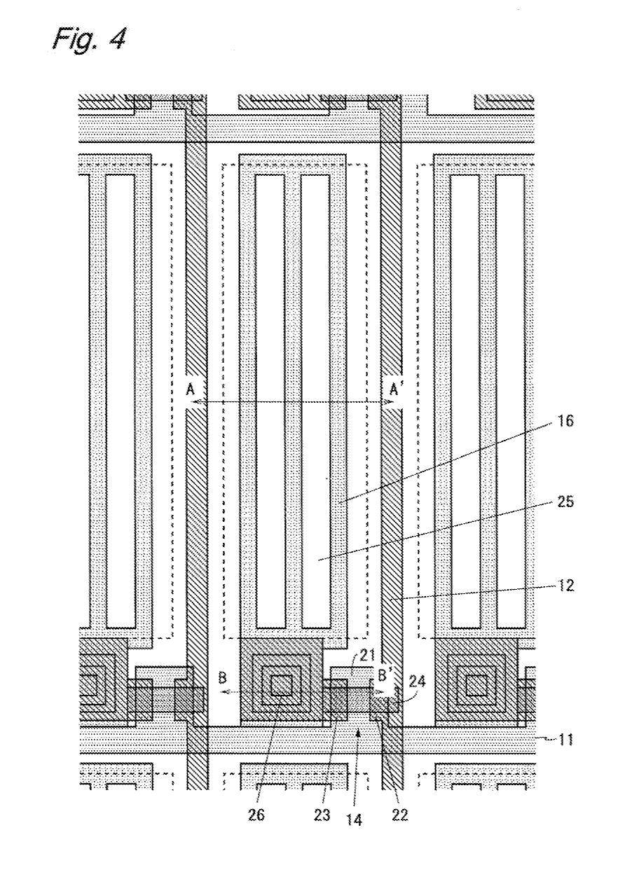

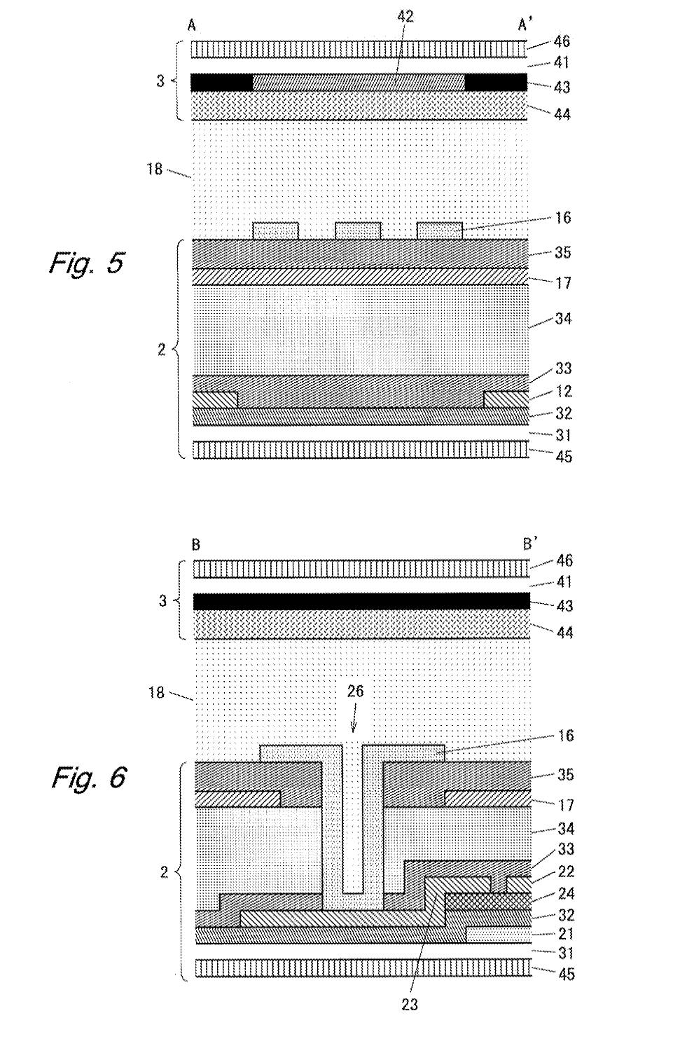

FIG. 3 is a layout diagram of the display area 4. FIG. 4 is an enlarged view of a portion X (portion surrounded by a long broken line) in FIG. 3. FIG. 5 is a cross-sectional view taken along a line A-A′ in FIG. 4. FIG. 6 is a cross-sectional view taken along a line B-B′ in FIG. 4. As shown in FIGS. 3 to 6, a gate electrode 21 and a source electrode 22 are formed near the intersection of the scanning line 11 and the data line 12. The gate electrode 21 is formed integrally with the scanning line 11 on the upper side (upper side in the drawings) of the scanning line 11. The source electrode 22 is formed integrally with the data line 12 and alternately on the left side and the right side of the data line 12 in units of two. A drain electrode 23 is formed at a position facing the source electrode 22, with the gate electrode 21 interposed therebetween. A semiconductor layer 24 is formed in an upper layer of the gate electrode 21 and in a lower layer of the source electrode 22 and the drain electrode 23. The gate electrode 21, the source electrode 22, the drain electrode 23, and the semiconductor layer 24 form the TFT 14. The pixel electrode 16 having slits 25 is formed in the pixel circuit 13. A contact hole 26 for electrically connecting the drain electrode 23 and the pixel electrode 16 is formed between the two electrodes. Note that in FIGS. 3 and 4, short broken lines show arrangement positions of a color filter (portion where a black matrix does not exist).

The TFT substrate 2 is manufactured, for example, by following steps (see FIGS. 5 and 6). First, a gate film is formed on a glass substrate 31, and the gate film is patterned to form the scanning line 11 and the gate electrode 21. Next, a gate insulating film 32 is formed on an entire surface of the substrate. Next, the semiconductor layer 24 is formed at a position where the TFT 14 is to be formed. Next, a source film is formed, and the source film is patterned to form the data line 12, the source electrode 22, and the drain electrode 23. Next, after forming a first passivation film 33 and applying an organic film 34, both are patterned to form a hole to be the contact hole 26 finally. Next, a common electrode film is formed, and the common electrode film is etched to form the common electrode 17. Next, after forming a second passivation film 35, the contact hole 26 penetrating the first passivation film 33, the organic film 34, and the second passivation film 35 is patterned. Next, a pixel electrode film is formed and the pixel electrode film is etched to form the pixel electrode 16 electrically connected to the drain electrode 23 through the contact hole 26.

The color filter substrate 3 is manufactured by providing a color filter 42 and a black matrix 43 on a glass substrate 41 and applying an overcoat 44 thereon. The TFT substrate 2 and the color filter substrate 3 are bonded to each other, and the liquid crystal 18 is sealed therebetween. Polarizing plates 45, 46 are respectively provided to both surfaces of the two bonded substrates.

Here, the reason why a color shift occurs when a conventional normally black type liquid crystal display device performing the 2H-Z inversion drive displays a specific pattern is described. In the conventional liquid crystal display device, the pixel circuits of the three primary colors are arranged in an order of the R pixel circuit, the G pixel circuit, and the B pixel circuit in any pixel. Hereinafter, a pattern with which white and black are displayed in a checkerboard pattern in units of pixels in two rows and one column is referred to as a greenish pattern.

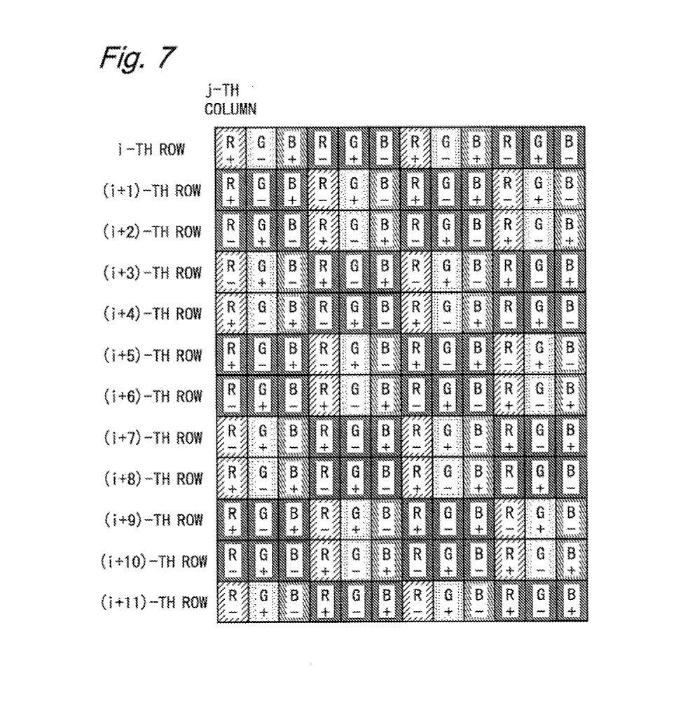

FIG. 7 is a diagram showing status when the conventional liquid crystal display device displays the greenish pattern. FIG. 7 describes, for each pixel circuit, a color of the pixel circuit (color of color filter and a polarity of a voltage written to the pixel circuit. The pixel circuit painted black is a pixel circuit of which display color is black. A zero voltage is written to the pixel circuit of which display color is black. Writing the voltage to the pixel circuit is performed in an ascending order of a row number. Hereinafter, the pixel circuit in an a-th row and a b-th column is referred to as P_{a, b}.

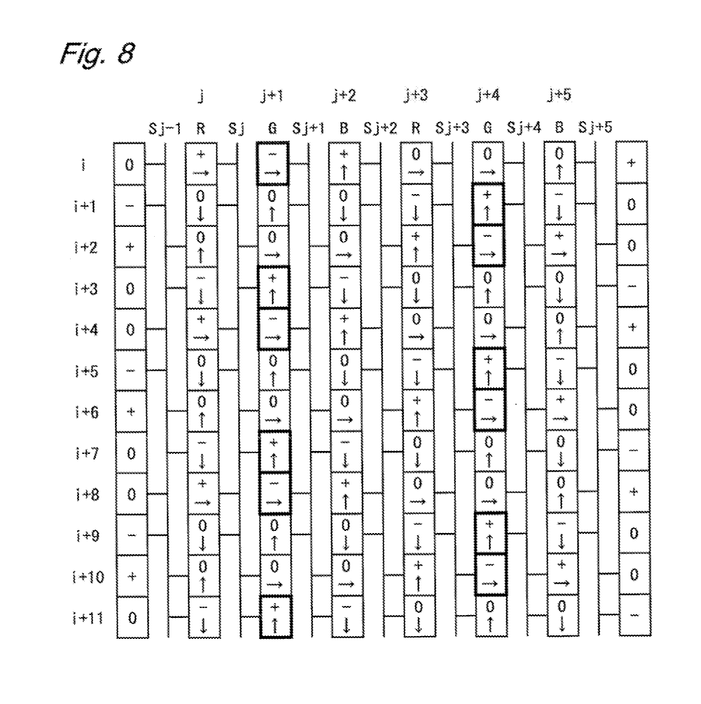

FIG. 8 is a diagram showing directions in which the polarities of the voltages applied to the data lines are made to change in a case shown in FIG. 7. FIG. 8 describes, for each pixel circuit, the polarity of the voltage written to the pixel circuit (“0” in case of zero voltage) and an arrow showing a direction of making the polarity of the voltage applied to the data line change when writing the voltage. An upward arrow shows that the polarity of the voltage is made to change in a positive direction, a downward arrow shows that the polarity of the voltage is made to change in a negative direction, and a rightward arrow shows that the polarity of the voltage is kept unchanged.

As shown in FIG. 8, pixel circuits P_{i, j}, P_{i+1, j}, P_{i+2, j+1}, P_{i+3, j+1}, . . . are connected to a data line Sj in the ascending order of the row number. A positive polarity voltage is written to the pixel circuit P_{i, j}, and the zero voltage is written to the next pixel circuit P_{i+1, j}. Thus, the downward arrow showing that the polarity of the voltage applied to the data line Sj is made to change in the negative direction is depicted in the pixel circuit P_{i+1, j}. The zero voltage is also written to the next pixel circuit P_{i+2, j+1}. Thus, the rightward arrow showing that the polarity of the voltage applied to the data line Sj is kept unchanged (zero voltage is continuously applied) is depicted in the pixel circuit P_{i+2, j+1}. The positive polarity voltage is written to the next pixel circuit P_{i+3, j+1}. Thus, the upward arrow showing that the polarity of the voltage written to the data line Sj is made to change in the positive direction is depicted in the pixel circuit P_{i+3, j+1}.

When writing the voltages to the pixel circuits included in the pixels in one row, the number of times the polarity of the voltage applied to the data line is made to change in the positive direction is denoted by Cp, and the number of times the polarity of the voltage applied to the data line is made to change in the negative direction is denoted by Cn. There exists a capacitance (not shown) between the data line and the common electrode. Therefore, when Cp>Cn is satisfied, the common electrode voltage Vcom is increased by a push up. Cp<Cn is satisfied, the common electrode voltage Vcom is decreased by a push down.

When focusing on a portion shown in FIG. 8, Cp=2 and Cn=0 in the i-th row (two upward arrows and zero downward arrows). The same holds true for other portions in the i-th row. Therefore, when writing the voltages to the pixels in the i-th row, Cp>Cn is satisfied and the common electrode voltage Vcom is increased by the push up. Furthermore, the positive polarity voltages are written to the pixel circuits P_{i, j}, P_{i, j+2} and a negative polarity voltage is written to a pixel circuit P_{i, j+1}. Therefore, in the pixel circuits P_{i, j}, P_{i, j+2}, a voltage applied to the liquid crystal is decreased by an amount that the common electrode voltage Vcom does not return to an original level by an influence of the push up before a voltage of the scanning line 11 becomes a level with which the TFT 14 turns off (hereinafter referred to as “a gate voltage becomes an off level”), and luminance of a corresponding subpixel is decreased depending on the push up. In the pixel circuit P_{i, j+1}, the voltage applied to the liquid crystal is increased by the amount that the common electrode voltage Vcom does not return to the original level by the influence of the push up before the gate voltage becomes the off level, and the luminance of the corresponding subpixel is increased depending on the push up. The same holds true for other portions in the i-th row. In this manner, the luminance of the G subpixel is increased and the luminances of the R subpixel and the B subpixel are decreased in the pixels in the i-th row.

When focusing on the portion shown in FIG. 8, Cp=2 and Cn=4 in the (i+1)-th row (two upward arrows and four downward arrows). The same holds true for other portions in the (i+1)-th row. Therefore, when writing the voltages to the pixels in the (i+1)-th row, Cp<Cn is satisfied and the common electrode voltage Vcom is decreased by the push down. Furthermore, the negative polarity voltages are written to pixel circuits P_{i+1, j+3}, P_{i+1, j+5} and the positive polarity voltage is written to a pixel circuit P_{i+1, j+4}. Therefore, in the pixel circuits P_{i+1, j+3}, P_{i+1, j+5}, the voltages applied to the liquid crystal are decreased by an amount that the common electrode voltage Vcom does not return to the original level by an influence of the push down before the gate voltage becomes the off level, and the luminance of the corresponding subpixel is decreased depending on the push down. In the pixel circuit P_{i+1, j+4}, the voltage applied to the liquid crystal is increased by the amount that the common electrode voltage Vcom does not return to the original level by the influence of the push down before the gate voltage becomes the off level, and the luminance of the corresponding subpixel is increased depending on the push down. The same holds true for other portions in the (i+1)-th row. In this manner, the luminance of the G subpixel is increased and the luminances of the R subpixel and the B subpixel are decreased in the pixels in the (i+1)-th row, as with the pixels in the i-th row.

In the pixels in the (i+2)-th row, an (i+4)-th row, and the like, the luminance of the G subpixel is increased and the luminances of the R subpixel and the B subpixel are decreased for the same reason as the pixels in the i-th row. In the pixels in the (i+3)-th row, an (i+5)-th row, and the like, the luminance of the G subpixel is increased and the luminances of the R subpixel and the B subpixel are decreased for the same reason as the pixels in the (i+1)-th row. In this manner, when displaying the greenish pattern, in any row, the luminance of the G subpixel (subpixel corresponding to a pixel circuit enclosed by a bold line in FIG. 8) is increased and the luminances of the R subpixel and the B subpixel (subpixels corresponding to pixel circuits on both sides of the pixel circuit surrounded by the bold line in FIG. 8) are decreased. Therefore, a color of a display screen looks greenish gray. For the reasons described above, the color shift occurs when the conventional liquid crystal display device performing the 2H-Z inversion drive displays the greenish pattern.

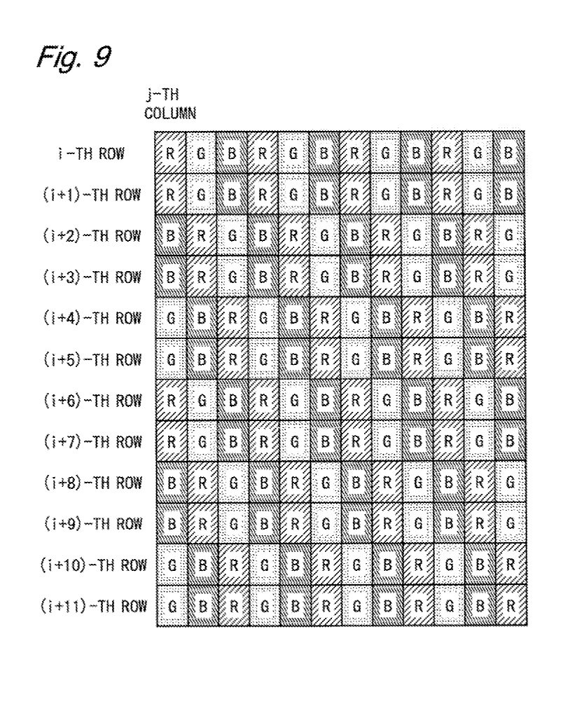

In order to prevent the color shift, the liquid crystal display device 1 according to the present embodiment has a pixel circuit arrangement different from that in the conventional liquid crystal display device. FIG. 9 is a diagram showing an arrangement of the pixel circuits in the liquid crystal display device 1. In the liquid crystal display device 1, the pixel circuits 13 are arranged so that a row in which the pixel circuits of the three primary colors are aligned in an order of red, green, and blue, a row in which the pixel circuits of the three primary colors are aligned in an order of blue, red, and green, and a row in which the pixel circuits of the three primary colors are aligned in an order of green, blue, and red are aligned in units of two in the column direction. Specifically, as shown in FIG. 9, in the pixels in the i-th and (i+1)-th rows, the pixel circuits of the three primary colors are arranged in an order of the R pixel circuit, the G pixel circuit, and the B pixel circuit. In the pixels in the (i+2)-th and (i+3)-th rows, the pixel circuits of the three primary colors are arranged in an order of the B pixel circuit, the R pixel circuit, and the G pixel circuit. In the pixels in the (i+4)-th and (i+5)-th rows, the pixel circuits of the three primary colors are arranged in an order of the G pixel circuit, the B pixel circuit, and the R pixel circuit. The same holds true for the pixels in other rows.

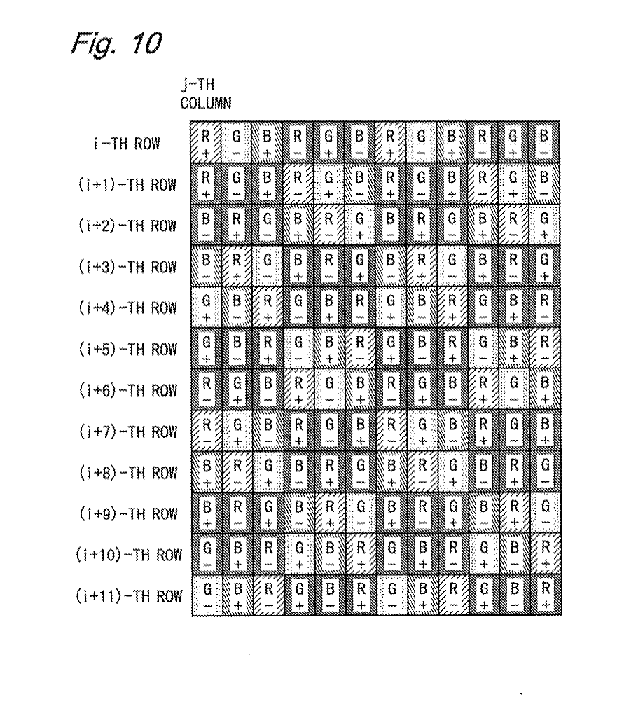

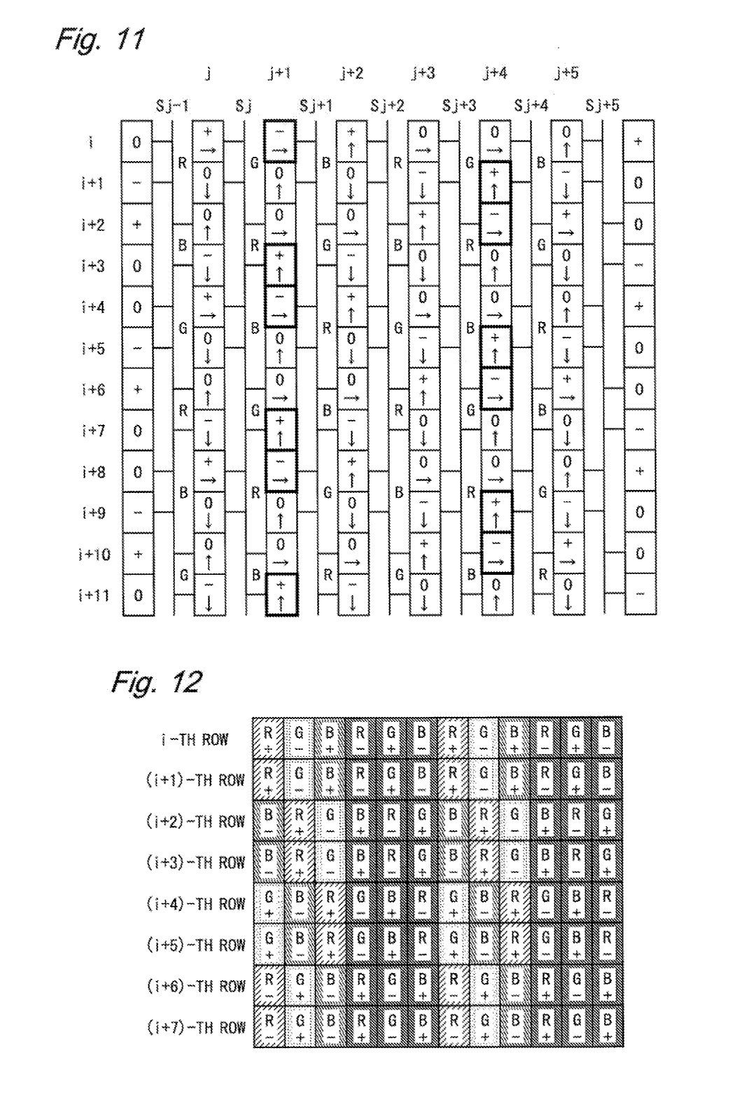

FIG. 10 is a diagram showing status when the liquid crystal display device 1 displays the greenish pattern. FIG. 11 is a diagram showing directions in which the polarities of the voltage applied to the data line 12 are made to change in a case shown in FIG. 10. Between the pixel circuits located at a same position in FIGS. 7 and 10, the polarities of the voltages written to the pixel circuits are same. Thus, between the pixel circuits located at a same position in FIGS. 8 and 11, the directions (directions shown by arrows) in which the polarities of the voltages applied to the data line are made to change are same. Therefore, in the liquid crystal display device 1, as with the conventional liquid crystal display device, the common electrode voltage Vcom is increased by the push up when writing the voltages to the pixels in the i-th row, the (i+2)-th row, and the like, and is decreased by the push down when writing the voltages to the pixels in the (i+1)-th row, the (i+3)-th row, and the like.

The liquid crystal display device 1 writes the positive polarity voltages to the pixel circuits P_{i, j}, P_{i, j+2} and writes the negative polarity voltage to the pixel circuit P_{i, j+1}. Since the common electrode voltage Vcom is increased by the push up at this time, the luminances of the subpixels corresponding to the pixel circuits P_{i, j}, P_{i, j+2} are decreased depending on the push up and the luminance of the subpixel corresponding to the pixel circuit P_{i, j+1} is increased depending on the push up. In the liquid crystal display device 1, the pixel circuits P_{i, j}, P_{i, j+1}, P_{i, j+2} are the R pixel circuit, the G pixel circuit, and the B pixel circuit, respectively. Therefore, in the pixels in the i-th row, the luminance of the G subpixel is increased and the luminances of the R subpixel and the B subpixel are decreased.

The liquid crystal display device 1 writes the negative polarity voltages to the pixel circuits P_{i+1, j+3} , P_{i+1, j+5} and writes the positive polarity voltage to the pixel circuit P_{i+1, j+4}. Since the common electrode voltage Vcom is decreased by the push down at this time, the luminances of the subpixels corresponding to the pixel circuits P_{i+1, j+3}, P_{i+1, j+5} are decreased depending on the push down and the luminance of the subpixel corresponding to the pixel circuit P_{i+1, j+4} is increased depending on the push down. In the liquid crystal display device 1, the pixel circuits P_{i+1, j+3}, P_{i+1, j+4}, P_{i+1, j+5} are the R pixel circuit, the G pixel circuit, and the B pixel circuit, respectively. Therefore, in the pixels in the (i+1)-th row, the luminance of the G subpixel is increased and the luminances of the R subpixel and the B subpixel are decreased, as with the pixels in the i-th row.

The liquid crystal display device 1 writes the positive polarity voltages to pixel circuits P_{i+2, j+3}, P_{i+2, j+5} and writes the negative polarity voltage to a pixel circuit P_{i+2, j+4}. Since the common electrode voltage Vcom is increased by the push up at this time, the luminances of the subpixels corresponding to the pixel circuits P_{i+2, j+3}, P_{i+2, j+5} are decreased depending on the push up and the luminance of the subpixel corresponding to the pixel circuit P_{i+2, j+4} is increased depending on the push up. In the liquid crystal display device 1, the pixel circuits P_{i+2, j+3}, P_{i+2, j+4}, P_{i+2, j+5} are the B pixel circuit, the R pixel circuit, and the G pixel circuit, respectively. Therefore, in the pixels in the (i+2)-th row, the luminance of the R subpixel is increased and the luminances of the G subpixel and the B subpixel are decreased.

The liquid crystal display device 1 writes the negative polarity voltages to pixel circuits P_{i+3, j}, P_{i+3, j+2} and writes the positive polarity voltage to the pixel circuit P_{i+3, j+1}. Since the common electrode voltage Vcom is decreased by the push down at this time, the luminances of the subpixels corresponding to the pixel circuits P_{i+3, j}, P_{i+3, j+2} are decreased depending on the push down and the luminance of the subpixel corresponding to the pixel circuit P_{i+3, j+1} is increased depending on the push down. In the liquid crystal display device 1, the pixel circuits P_{i+3, j}, P_{i+3, j+1}, P_{i+3, j+2} are the B pixel circuit, the R pixel circuit, and the G pixel circuit, respectively. Therefore, in the pixels in the (i+3)-th row, the luminance of the R subpixel is increased and the luminances of the G subpixel and the B subpixel are decreased, as with the pixels in the (i+2)-th row.

The liquid crystal display device 1 writes the positive polarity voltages to pixel circuits P_{i+4, j}, P_{i+4, j+2} and writes the negative polarity voltage to a pixel circuit P_{i+4, j+1}. Since the common electrode voltage Vcom is increased by the push up at this time, the luminances of the subpixels corresponding to the pixel circuits P_{i+4, j}, P_{i+4, j+2} are decreased depending on the push up and the luminance of the subpixel corresponding to the pixel circuit P_{i+4, j+1} is increased depending on the push up. In the liquid crystal display device 1, the pixel circuits P_{i+4, j}, P_{i+4, j+1}, P_{i+4, j+2} are the G pixel circuit, the B pixel circuit, and the R pixel circuit, respectively. Therefore, in the pixels in the (i+4)-th row, the luminance of the B subpixel is increased and the luminances of the R subpixel and the G subpixel are decreased.

The liquid crystal display device 1 writes the negative polarity voltages to pixel circuits P_{i+5, j+3}, P_{i+5, j+5} and writes the positive polarity voltage to a pixel circuit P_{i+5, j+4}. Since the common electrode voltage Vcom is decreased by the push down at this time, the luminances of the subpixels corresponding to the pixel circuits P_{i+5, j+3}, P_{i+5, j+5} are decreased depending on the push down and the luminance of the subpixel corresponding to the pixel circuit P_{i+5, j+4} is increased depending on the push down. In the liquid crystal display device 1, the pixel circuits P_{i+5, j+3}, P_{i+5, j+4}, P_{i+5, j+5} are the G pixel circuit, the B pixel circuit, and the R pixel circuit respectively. Therefore, in the pixels in the (i+5)-th row, the luminance of the B subpixel is increased and the luminances of the R subpixel and the G subpixel are decreased, as with the pixels in the (i+4)-th row.

As described above, in the pixels in the i-th and (i+1)-th rows, the luminance of the G subpixel is increased and the luminances of the R subpixel and the B subpixel are decreased. Thus, when looking at only the pixels in the i-th and (i+1)-th rows, it looks greenish gray. In the (i+2)-th and (i+3)-th rows, the luminance of the R subpixel is increased and the luminances of the G subpixel and the B subpixel are decreased. Thus, when looking at only the pixels in the (i+2)-th and (i+3)-th rows, it looks reddish gray. In the (i+4)-th and (i+5)-th rows, the luminance of the B subpixel is increased and the luminances of the R subpixel and the G subpixel are decreased. Thus, when looking at only the pixels of the (i+4)-th and (i+5)-th rows, it looks blueish gray. The same holds true for the pixels in other rows.

When the display screen of the liquid crystal display device 1 is seen from a position apart to some extent, the color of the display screen looks gray (correct color), because the display colors of the pixels in the above six rows are averaged. Therefore, according to the liquid crystal display device 1 according to the present embodiment, the 2H-Z inversion drive can be performed and the color shift when displaying the greenish pattern can be prevented.

FIG. 12 is a diagram showing status when the liquid crystal display device 1 displays a stripe pattern with which white and black are alternately displayed in units of a column of the pixels. When displaying the stripe pattern, the color shift occurs to a degree smaller than when displaying the greenish pattern. However, an occurrence frequency of the stripe pattern is larger than an occurrence frequency of the greenish pattern. According to the liquid crystal display device 1, even when displaying the stripe pattern, the color shift can be prevented for the same reason as when displaying the greenish pattern.

As described above, the liquid crystal display device 1 according to the present embodiment includes the scanning lines 11 extending in the row direction, the data lines 12 extending in the column direction, pixel circuits 13, each arranged corresponding to the intersection of the scanning line 11 and the data line 12 and connected to one corresponding data line 12, the scanning line drive circuit 5 configured to select the scanning lines 11 sequentially, and the data line drive circuit 6 configured to drive the data lines 12. The data line drive circuit 6 applies the voltages of different polarities to the adjacent data lines 12. The pixel circuits 13 are alternately connected to both sides of the data line 12 in units of two. The pixel circuits 13 are arranged so that the row in which the pixel circuits 13 of the three primary colors are aligned in the order of red, green, and blue, the row in which the pixel circuits 13 of the three primary colors are aligned in the order of the blue, red, and green, and the row in which the pixel circuits 13 of the three primary colors are aligned in the order of green, blue, and red are aligned in units of two in the column direction.

Therefore, according to the liquid crystal display device 1 according to the present embodiment, by applying the voltages of different polarities to the adjacent data lines 12 under circumstance where the pixel circuits 13 are alternately arranged on both sides of the data line 12 in units of two, the 2H-Z inversion drive can be performed. Thus, power consumption when displaying a red, green, or blue image can be reduced, when compared with a case of performing the 1H-Z inversion drive. Furthermore, since the pixel circuits 13 of the three primary colors are arranged in units of two rows in three types of orders, even when displaying a specific pattern (greenish pattern) that causes the color shift, display colors of the pixels in six rows are averaged and the color shift can be prevented.

Furthermore, the pixel circuit 13 includes the pixel electrode 16 and the common electrode 17 both corresponding to the FFS method. Therefore, in the liquid crystal display device 1 adopting the FFS method, the 2H-Z inversion drive can be performed and the color shift when displaying the specific pattern can be prevented.

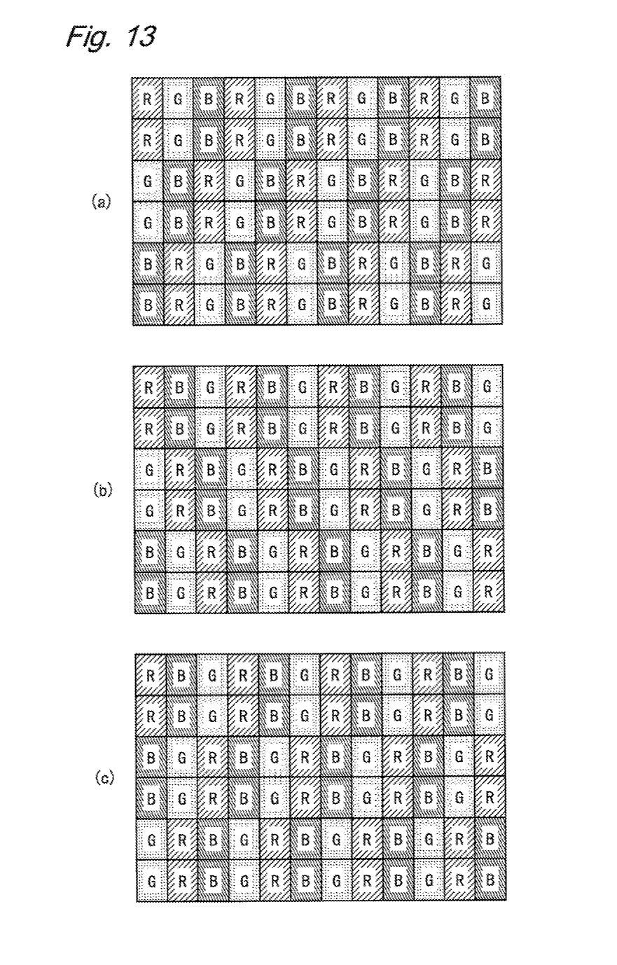

Note that in the liquid crystal display device 1, the pixel circuits 13 may be arranged as shown in any of FIGS. 13(a) to (c). In any arrangement shown in FIGS. 13(a) to (c), as with the arrangement shown in FIG. 9, the pixel circuits 13 are arranged so that the row in which the pixel circuits 13 of the three primary colors are aligned in the order of red, green, and blue, the row in which the pixel circuits 13 of the three primary colors are aligned in the order of blue, red, and green, and the row in which the pixel circuits 13 of the three primary colors are aligned in the order of green, blue, and red are aligned in units of two in the column direction. For example, in the arrangement shown in FIG. 13(b), the pixel circuits 13 are arranged so that the row in which the pixel circuits 13 of the three primary colors are aligned from right in the order of red, green, and blue, the row in which the pixel circuits 13 of the three primary colors are aligned from right in the order of blue, red, and green, and the row in which the pixel circuits 13 of the three primary colors are aligned from right in the order of green, blue, and red are aligned in units of two in the column direction from bottom.

### Second Embodiment

A liquid crystal display device according to a second embodiment has a same overall structure (FIG. 1) as the liquid crystal display device 1 according to the first embodiment, has a same connection style of the pixel circuits (FIG. 2) as the liquid crystal display device 1, and performs the 2H-Z inversion drive as with the liquid crystal display device 1. Furthermore, the liquid crystal display device according to the present embodiment has a same arrangement of the pixel circuits (FIG. 9) as the liquid crystal display device 1. The liquid crystal display device according to the present embodiment and the liquid crystal display device 1 are different in a layout of the display area 4.

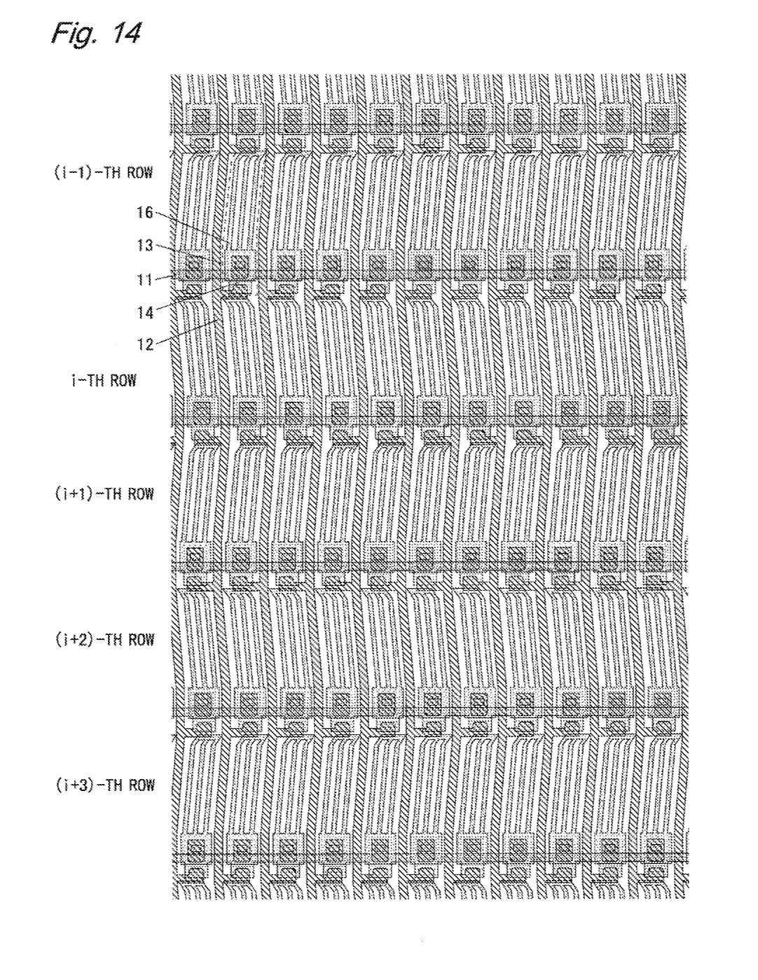

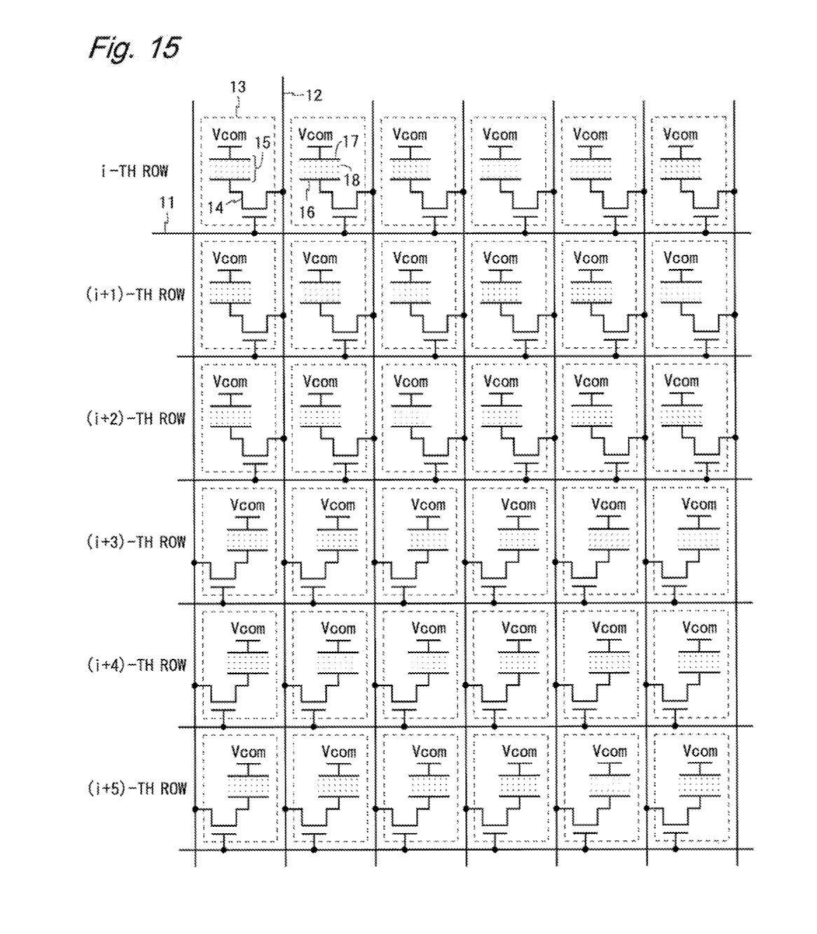

FIG. 14 is a layout diagram of the display area 4 of the liquid crystal display device according to the present embodiment. As shown in FIG. 14, the scanning line 11 extends in the row direction, and the data line 12 extends in the column direction with bending in a zigzag manner. The pixel circuit 13 (portion shown by a broken line) is formed corresponding to the intersection of the scanning line 11 and the data line 12, and includes the TFT 14 and the pixel capacitance (not shown). The pixel capacitance has the pixel electrode 16 having slits formed thereon and the common electrode (not shown).

The scanning line 11 is arranged corresponding to a bending point of the data line 12. Sizes in the column direction of the pixel circuit 13 and the pixel electrode 16 are substantially equal to an interval between the bending points of the data line 12. The pixel circuit 13 and the pixel electrode 16 included therein have shapes inclined from the column direction depending on a bending direction of the data line 12. Specifically, the pixel circuits 13 in the i-th row, the (i+2)-th row, the (i+3)-th row, and the like and the pixel electrodes 16 included therein have shapes of which upper portion is inclined to left from the column direction. The pixel circuits 13 in the (i+1)-th row, the (i+3)-th row, and the like and the pixel electrodes 16 included therein have shapes of which upper portion is inclined to right from the column direction. In this manner, the pixel circuits 13 adjacent in the column direction include the pixel electrodes 16 having shapes different from each other. The pixel circuits 13, are alternately connected to both sides of the data line 12 in units of two. Specifically, as shown in FIG. 14, the pixel circuits 13 in the i-th row, the (i+1)-th row, and the like are connected to the left side of the data line 12, and the pixel circuits 13 in the (i+2)-th, the (i+3)-th row, and the like are connected to the right side of the data line 12. An arrangement of the pixel circuits shown in FIG. 14 is called a pseudo dual domain.

According to the liquid crystal display device having pseudo dual domain configuration, coloring when the display screen is seen from an oblique direction can be reduced while narrowing a pixel pitch and keeping high transmittance. In the liquid crystal display device having the pseudo dual domain configuration, viewing angle characteristics are mutually complemented between two pixel circuits adjacent in the column direction. Therefore, in order to improve a flicker ratio and flicker shift, it is preferable to write voltages of a same polarity to the two pixel circuits adjacent in the column direction. Thus, the liquid crystal display device having the pseudo dual domain configuration performs the 2H-Z inversion drive.

As with the liquid crystal display device 1 according to the first embodiment, the liquid crystal display device according to the present embodiment has the arrangement of the pixel circuits shown in FIG. 9. Therefore, according to the liquid crystal display device according to the present embodiment, as with the liquid crystal display device 1 according to the first embodiment, the 2H-Z inversion drive can be performed and the color shift which occurs when displaying the greenish pattern can be prevented.

Furthermore, in the liquid crystal display device according to the present embodiment, the data line 12 extends in the column direction with bending in the zigzag manner, the scanning line 11 is arranged corresponding to the bending point of the data line 12, and the pixel circuits 13 adjacent in the column direction include the pixel electrodes 16 having shapes different from each other. Therefore, according to the liquid crystal display device according to the present embodiment, since the pixel electrodes 16 in the pixel circuits 13 adjacent in the column direction have different shapes, the coloring when the display screen is seen from the oblique direction can be reduced. Furthermore, the flicker rate and the flicker shift can be improved by performing the 2H-Z inversion drive.

### Third Embodiment

A liquid crystal display device according to a third embodiment has the same overall configuration (FIG. 1) as the liquid crystal display device 1 according to the first embodiment. The liquid crystal display device according to the present embodiment has a connection style of the pixel circuits different from that in the liquid crystal display device 1, and performs a 3H-Z inversion drive instead of the 2H-Z inversion drive. Differences from the liquid crystal display device 1 according to the first embodiment are described below.

FIG. 15 is a circuit diagram of the display area 4 of the liquid crystal display device according to the present embodiment. In the liquid crystal display device according to the present embodiment, the pixel circuits 13 are alternately connected to both sides of the data line 12 in units of three. Specifically, as shown in FIG. 15, the pixel circuits 13 in the i-th to (i+2)-th rows are connected to the left side of the data line 12, and the pixel circuits 13 in the (i+3)-th to (i+5)-th rows are connected to the right side of the data line 12. Furthermore, the pixel circuits 13 in (i+6)-th to (i+8)-th rows, and the like are connected to the left side of the data line 12, and the pixel circuits 13 in (i+9)-th to (i+11)-th rows, and the like are connected to the right side of the data line 12 (not shown).

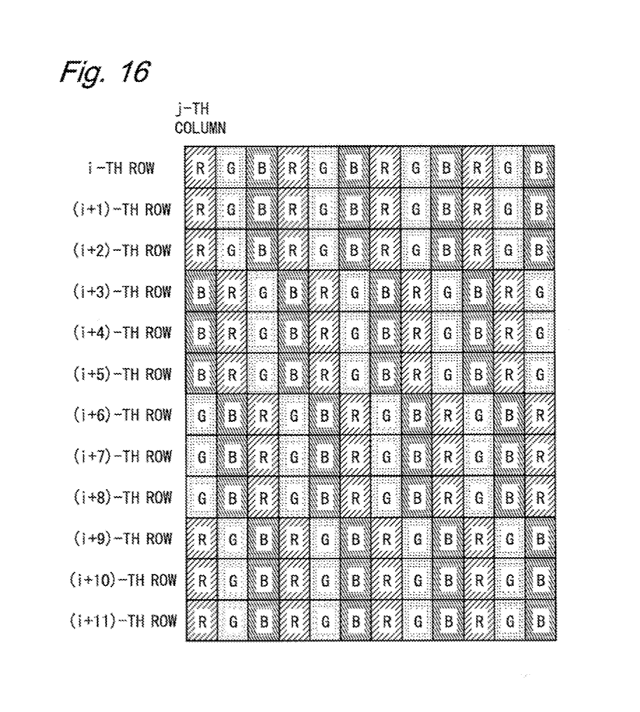

FIG. 16 is a diagram showing an arrangement of the pixel circuits in the liquid crystal display device according to the present embodiment. In the liquid crystal display device according to the present embodiment, the pixel circuits 13 are arranged so that the row in which the pixel circuits of the three primary colors are aligned in the order of red, green, and blue, the row in which the pixel circuits of the three primary colors are aligned in the order of blue, red, and green, and the row in which the pixel circuits of the three primary colors are aligned in the order of green, blue, and red are aligned in units of three in the column direction. Specifically, as shown in FIG. 16, in the pixels in the i-th to (i+2)-th rows, the pixel circuits of the three primary colors are arranged in the order of the R pixel circuit, the G pixel circuit, and the B pixel circuit. In the (i+3)-th to (i+5)-th rows, the pixel circuits of the three primary colors are arranged in the order of the B pixel circuit, the R pixel circuit, and the G pixel circuit. In the pixels of the (i+6)-th to (i+8)-th rows, the pixel circuits of the three primary colors are arranged in the order of the G pixel circuit, the B pixel circuit, and the R pixel circuit. The same holds true for the pixels in other rows.

In the present embodiment, a pattern with which white and black are alternately displayed in units of a pixel in a certain row and a next row and white and black are alternately displayed in an opposite order in units of a pixel in a further next row is called a greenish pattern. In a conventional normally black type liquid crystal display device performing the 3H-Z inversion drive, when displaying the greenish pattern, the color of the display screen looks greenish gray.

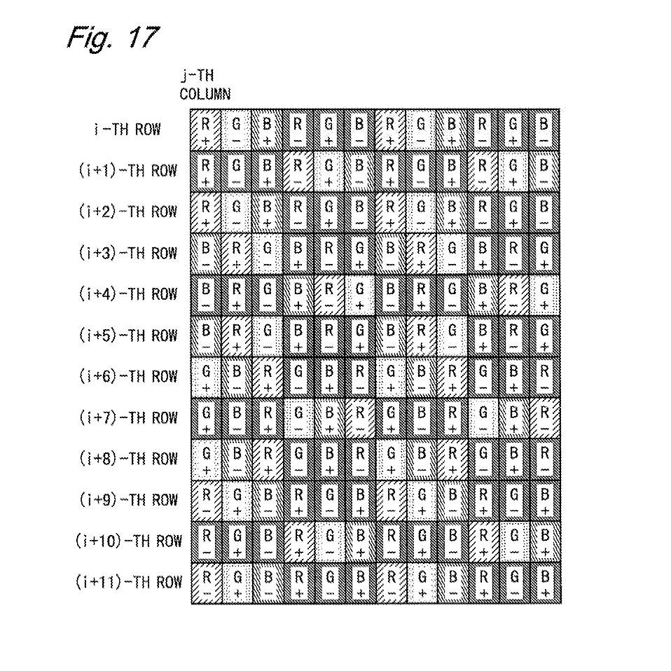

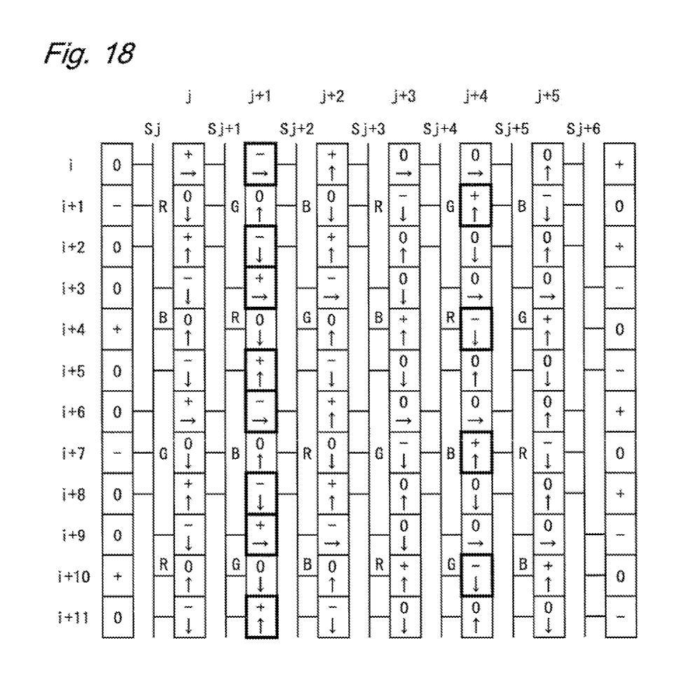

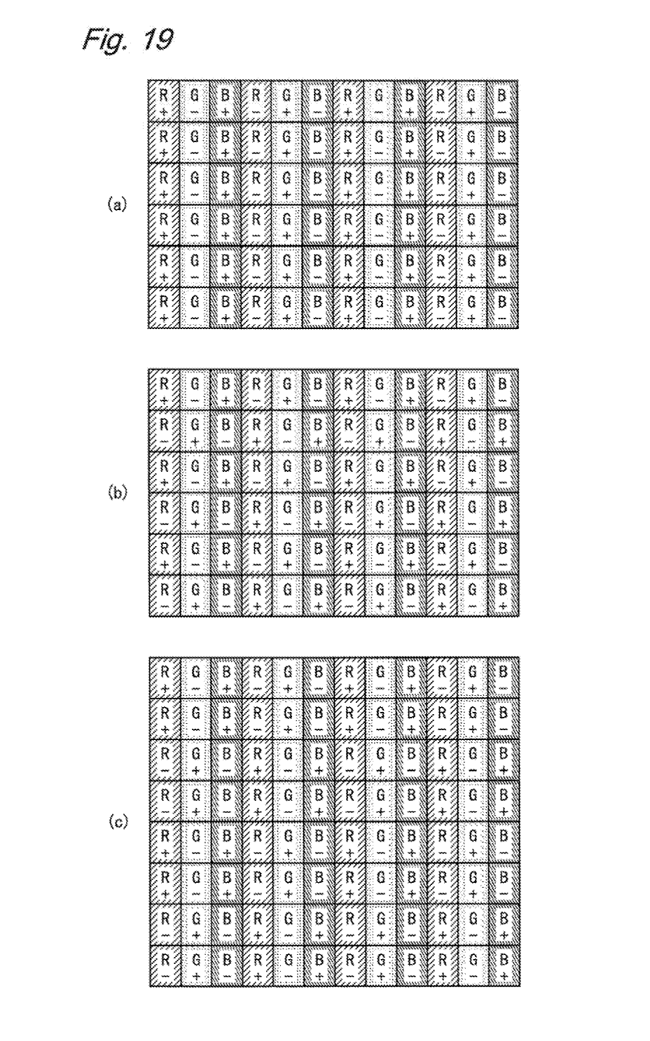

FIG. 17 is a diagram showing status when the liquid crystal display device according to the present embodiment displays the greenish pattern. FIG. 18 is a diagram showing directions in which the polarities of the voltages applied to the data line 12 are made to change in a case shown in FIG. 17. In the liquid crystal display device according to the present embodiment, in the pixels in the i-th to (i+2)-th rows, the luminance of the G subpixel is increased and the luminances of the R subpixel and the B subpixel are decreased. Thus, when looking at only the pixels in the i-th to (i+2)-th rows, it looks greenish gray in the (i+3)-th to (i+5)-th rows, the luminance of the R subpixel is increased and the luminances of the G subpixel and the B subpixel are decreased. Thus, when looking at only the pixels in the (i+3)-th to (i+5)-th rows, it looks reddish gray. In the (i+6)-th to (i+8)-th rows, the luminance of the B subpixel is increased and the luminance of the R subpixel and the G subpixel are decreased. Thus, when looking at only the pixels in the (i+6)-th to (i+8)-th rows, it looks blueish gray. The same holds true for the pixels in other rows.

When the display screen of the liquid crystal display device according to the present embodiment is seen from a position apart to some extent, the color of the display screen looks gray (correct color), because the display colors of the pixels in the above nine rows are averaged. Therefore, according to the liquid crystal display device according to the present embodiment, even when performing the 3H-Z inversion drive and displaying the greenish pattern, the display colors of the pixels in the nine rows are averaged and the color shift can be prevented.

As for the liquid crystal display devices according to the above embodiments, following modifications can be configured. In the first and second embodiments, the pixel circuits 13 are alternately connected to both sides of the data line 12 in units of two and the pixel circuits of the three primary colors are arranged in units of two rows in three types of orders, and in the third embodiment, the pixel circuits 13 are alternately connected to both Sides of the data line 12 in units of three and the pixel circuits of the three primary colors are arranged in units of three rows in three types of orders. In a liquid crystal display device according to a modification, the pixel circuits 13 may be alternately connected to both sides of the data line 12 in units of a predetermined number which is not smaller than one, and the pixel circuits of the three primary colors may be arranged in units of the number in three types of orders. Furthermore, the FFS method is adopted as the orientation method in the first and second embodiments. In a liquid crystal display device according to a modification, TN (Twisted Nematic) method or ASV (Advanced Super View) method may be adopted as the orientation method. According to the liquid crystal display devices according to these modifications, effects similar to those of the liquid crystal display devices according to the first to third embodiments can be attained.

As described above, a liquid crystal display device may be an active matrix type liquid crystal display device, including: scanning lines extending in a row direction; data lines extending in a column direction; pixel circuits, each arranged corresponding to an intersection of the scanning line and the data line and connected to one corresponding data line; a scanning line drive circuit configured to select the scanning lines sequentially; and a data line drive circuit configured to drive the data lines, the data line drive circuit may apply voltages of different polarities to adjacent data lines, the pixel circuits may be alternately connected to both sides of the data line in units of a predetermined number, the number being not smaller than one, and the pixel circuits may be arranged so that a row in which the pixel circuits of three primary colors are aligned in an order of red, green, and blue, a row in which the pixel circuits of the three primary colors are aligned in an order of blue, red, and green, and a row in which the pixel circuits of the three primary colors are aligned in an order of green, blue, and red are aligned in units of the number in the column direction (first aspect).

The number may be two (second aspect). The data line may extend in the column direction with bending in a zigzag manner, the scanning line may be arranged corresponding to a bending point of the data line, and the pixel circuits adjacent in the column direction may include pixel electrodes having shapes different from each other (third aspect). Alternatively, the number may be three (fourth aspect). The pixel circuit may include a pixel electrode and a common electrode both corresponding to an FFS (Fringe Field Switching) method (fifth aspect).

A drive method for a liquid crystal display device may be a drive method for an active matrix type liquid crystal display device having scanning lines extending in a row direction, data lines extending in a column direction, and pixel circuits, each arranged corresponding to an intersection of the scanning line and the data line and connected to one corresponding data line, the method including the steps of: selecting the scanning lines sequentially; and driving the data lines, and in driving the data lines, voltages of different polarities may be applied to adjacent data lines, the pixel circuits may be alternately connected to both sides of the data line in units of a predetermined number, the number being not smaller than one, and the pixel circuits may be arranged so that a row in which the pixel circuits of three primary colors are aligned in an order of red, green, and blue, a row in which the pixel circuits of the three primary colors are aligned in an order of blue, red, and green, and a row in which the pixel circuits of the three primary colors are aligned in an order of green, blue, and red are aligned in units of the number in the column direction (sixth aspect).

According to the first or sixth aspect, by applying voltages of different polarities to the adjacent data lines under circumstance where the pixel circuit are alternately arranged on both sides of the data line in units of n (n is an integer not smaller than one), an nH-Z inversion drive can be performed. With this, as the value of n is larger, power consumption when displaying a red, green, or blue image can be reduced. Furthermore, since the pixel circuits of the three primary colors are arranged in units of n row(s) in three types of orders, even when displaying a specific pattern which causes the color shift, the display colors of the pixels in 3n rows are averaged and the color shift can be prevented.

According to the second aspect, the 2H-Z inversion drive can be performed. Furthermore, even when displaying the specific pattern, the display colors of the pixels in six rows are averaged and the color shift can be prevented. According to the third aspect, since the pixel electrodes of the pixel circuits adjacent in the column direction have different shapes, coloring which occurs when the display screen is seen from an oblique direction can be reduced. Furthermore, the flicker rate and the flicker shift can be improved by performing the 2H-Z inversion drive. According to the fourth aspect, the 3H-Z inversion drive can be performed. Furthermore, even when displaying the specific pattern, the display colors of the pixels in nine rows are averaged and the color shift can be prevented. According to the fifth aspect, in the liquid crystal display device adopting the FFS method, the nH-Z inversion drive can be performed and the color shift which occurs when displaying the specific pattern can be prevented.

This application claims a priority based on Japanese Patent Application No. 2017-468 filed on Jan. 5, 2017 and entitled “Liquid Crystal Display Device And Drive Method For Same”, which is incorporated herein by reference in its entirety.

### DESCRIPTION OF REFERENCE CHARACTERS

1: LIQUID CRYSTAL DISPLAY DEVICE

2: TFT SUBSTRATE

3: COLOR FILTER SUBSTRATE

4: DISPLAY AREA

5: SCANNING LINE DRIVE CIRCUIT

6: DATA LINE DRIVE CIRCUIT

7: TERMINAL AREA

11: SCANNING LINE

12: DATA LINE

13: PIXEL CIRCUIT

14: TFT

15: PIXEL CAPACITANCE

16: PIXEL ELECTRODE

17: COMMON ELECTRODE

18: LIQUID CRYSTAL

1. An active matrix type liquid crystal display device, comprising:
scanning lines extending in a row direction;
data lines extending in a column direction;
pixel circuits, each arranged corresponding to an intersection of the scanning line and the data line and connected to one corresponding data line;
a scanning line drive circuit configured to select the scanning lines sequentially; and
a data line drive circuit configured to drive the data lines, wherein
the data line drive circuit applies voltages of different polarities to adjacent data lines,
the pixel circuits are alternately connected to both sides of the data line in units of a predetermined number, the number being not smaller than one, and
the pixel circuits are arranged so that a row in which the pixel circuits of three primary colors are aligned in an order of red, green, and blue, a row in which the pixel circuits of the three primary colors are aligned in an order of blue, red, and green, and a row in which the pixel circuits of the three primary colors are aligned in an order of green, blue, and red are aligned in units of the number in the column direction.

2. The liquid crystal display device according to claim 1, wherein the number is two.

3. The liquid crystal display device according to claim 2, wherein
the data line extends in the column direction with bending in a zigzag manner,
the scanning line is arranged corresponding to a bending point of the data line, and
the pixel circuits adjacent in the column direction include pixel electrodes having shapes different from each other.

4. The liquid crystal display device according to claim 1, wherein the number is three.

5. The liquid crystal display device according to claim 1, wherein the pixel circuit includes a pixel electrode and a common electrode both corresponding to an FFS (Fringe Field Switching) method.

6. A drive method for an active matrix type liquid crystal display device having scanning lines extending in a row direction, data lines extending in a column direction, and pixel circuits, each arranged corresponding to an intersection of the scanning line and the data line and connected to one corresponding data line, the method comprising steps of:
selecting the scanning lines sequentially; and
driving the data lines, wherein
in driving the data lines, voltages of different polarities are applied to adjacent data lines,
the pixel circuits are alternately connected to both sides of the data line in units of a predetermined number, the number being not smaller than one, and
the pixel circuits are arranged so that a row in which the pixel circuits of three primary colors are aligned in an order of red, green, and blue, a row in which the pixel circuits of the three primary colors are aligned in an order of blue, red, and green, and a row in which the pixel circuits of the three primary colors are aligned in an order of green, blue, and red are aligned in units of the number in the column direction.
